(19) United States
(12) Patent Application Publication
(10) Pub. No.: US 2013/0159642 A1
(43) Pub. Date: Jun. 20, 2013

(54) Method of Writing Firmware, Firmware Storage Medium, and Electronic Device

(71) Applicant: Seiko Epson Corporation, Tokyo (JP)

(72) Inventors: Shingo Todaka, Nagano-ken (JP); Isao Eguchi, Nagano-ken (JP)

(73) Assignee: Seiko Epson Corporation, Tokyo (JP)

(21) Appl. No.: 13/685,999

(22) Filed: Nov. 27, 2012

(30) Foreign Application Priority Data
Dec. 14, 2011 (JP) 2011-273637

(51) Int. Cl. G06F 12/02

(52) U.S. Cl. CPC G06F 12/02
USPC 711/156

(57) ABSTRACT

Writing only incompatible firmware is reliably prevented without limiting writing other firmware. A firmware storage area is reserved in printer memory, and an evaluation area for writing evaluation data is reserved in the boot sector at the beginning of the firmware storage area. When the firmware overwriting process starts, the printer control unit gets the evaluation data, which is firmware data overwritten to a fixed address set as the evaluation area, and based on this evaluation data determines whether to complete or abort the firmware writing process.

### CROSS REFERENCE TO RELATED APPLICATION

Priority is claimed under 35 U.S.C. §119 to Japanese Application No. 2011-273637 filed on Dec. 14, 2011, which is hereby incorporated by reference in its entirety.

### BACKGROUND

1. Technical Field

The present invention relates to a method of writing firmware that controls an electronic device, a storage medium for storing firmware that can be executed by a control unit to control the electronic device, and the electronic device.

2. Related Art

Printers and other electronic devices typically have firmware for controlling the operation and components of the electronic device. When components of the electronic device are replaced with incompatible ones that cannot be controlled by the existing firmware, the firmware must be changed and the firmware stored in the electronic device must be overwritten with the new firmware. Firmware can also be modified and overwritten to change how components of the electronic device are controlled to, for example, improve certain functions or prevent unnecessary functions from working.

The firmware must therefore be compatible with the components of the electronic device, and installing firmware that is not compatible with device components can result in problems such as parts being damaged or rendered inoperable as a result of being controlled incorrectly. Various methods can be used to avoid this. For example, a model ID could be stored in the electronic device and used to determine whether to allow overwriting the firmware.

Japanese Unexamined Patent Appl. Pub. JP-A-2006-139665 describes an electronic device (a multifunction facsimile machine) that can handle the installation of the wrong firmware. When the firmware is overwritten in the multifunction facsimile machine described in JP-A-2006-139665, the current firmware is first saved to memory and the new firmware is then written. If the multifunction facsimile machine cannot restart after the new firmware is installed, the old firmware that was saved to memory is written over the new firmware to restore the machine to the previous state in response to input indicating that the new firmware is incompatible with the machine.

While the method taught in JP-A-2006-139665 enables restoring the electronic device to the previous state when the wrong firmware is installed, it cannot prevent writing the wrong firmware in the first place. Using the model ID to determine whether or not to overwrite the firmware can also prevent installing firmware for a different model, but when the firmware is upgraded in the same device model to solve a problem or handle changing some part, that model will also be recognized when reinstalling the old firmware is attempted, and overwriting will be allowed.

When an old model of a printer or other electronic device is used for a long time, some components may be replaced with other parts because they have become obsolete or are no longer available, and this may require an upgrade to new firmware. In this case, reinstalling the old firmware (downgrading to the old firmware) cannot be prevented because old firmware that is compatible with the original parts configuration and incompatible with the new configuration cannot be identified from the model ID. Identifying old firmware and preventing downgrading in this situation is possible if the model ID is changed, but changing the model ID also makes changing (upgrading) the firmware impossible.

Determining whether or not to allow overwriting the firmware based on firmware version information could conceivably be used to prevent downgrading to firmware that is compatible with an electronic device having an older parts configuration that is different from the current configuration. However, simply prohibiting overwriting new firmware with an older version also prohibits downgrading to a safe version that will not create such problems as damage to parts or prevent operation, and overwriting the firmware is thus unnecessarily limited.

### SUMMARY

A method of writing firmware, a firmware storage medium, and an electronic device according to the invention can reliably prevent only overwriting firmware with incompatible firmware without unnecessarily limiting overwriting firmware.

A first aspect of the invention is a method of writing firmware in an electronic device, wherein: part of the firmware storage area in the electronic device is reserved as an evaluation area for determining whether to allow overwriting the firmware; and a control unit of the electronic device executes a first step of starting to acquire overwrite data for overwriting the firmware, and acquiring evaluation data for overwriting the evaluation area, based on input of a firmware overwrite command, a second step of deciding whether to overwrite the firmware based on the content of the acquired evaluation data, and completes overwriting the firmware when overwriting the firmware is allowed in the second step.

As described above, this aspect of the invention acquires evaluation data for overwriting a predetermined area (evaluation area) in firmware memory, and based on the content of this data determines whether to allow overwriting the firmware before completing the firmware writing process. This step only needs to read the evaluation data to be written to a fixed address (evaluation area) in the firmware memory, and can therefore easily determine whether the firmware can be overwritten. Unlike simple version information, the information written to the evaluation area can be set to content enabling determining the compatibility of the firmware with the electronic device. Overwriting the current firmware with incompatible firmware can therefore be prohibited by referring to the evaluation data to be written to the evaluation area. Overwriting firmware with incompatible firmware can therefore be reliably prevented without unnecessarily restricting overwriting the firmware.

In an electronic device according to another aspect of the invention, the electronic device has a plurality of parts that are controlled by the firmware; and the evaluation area is a data area where information about at least one of the plural parts is written. By being able to determine if the firmware is compatible with controlling the parts configuration based on the parts information, this aspect of the invention can prevent only writing firmware that cannot correctly control the electronic device.

In an electronic device according to another aspect of the invention, the control unit of the electronic device compares data read from the evaluation area with the evaluation data in the second step, and determines that overwriting is not allowed if the data differ. This aspect of the invention can overwrite only firmware having common evaluation information, and can prohibit writing other firmware.

Further alternatively, the control unit of the electronic device determines whether the data read from the evaluation area or the evaluation data is newer in the second step, and allows overwriting only if the evaluation data is newer than the data read from the evaluation area. This prohibits only overwriting the firmware with firmware containing older evaluation information.

Further preferably, the evaluation area is reserved in the unit data storage area where data is written first in the firmware storage area. Whether or not the firmware can be overwritten can therefore be determined as soon as the first data unit is acquired after the overwriting process starts, and the overwriting decision can be made in a short time.

In another aspect of the invention, the electronic device is a printer or a device having a printer; and the evaluation area is a data area where information about a thermal head or motor in the printer is written. When an electronic device having a thermal head or motor is used for a long time, parts may be replaced due to obsolescence, for example. When this happens, the firmware may also be changed and the old firmware may not be able to control the new parts. The thermal head or motor can therefore be protected from damage or being rendered inoperable by preventing overwriting the new firmware with the wrong firmware.

Another aspect of the invention is a storage medium storing firmware that can be run by a control unit of an electronic device, wherein: the firmware includes a firmware writing program to execute the firmware writing method described above; firmware to control the electronic device; and evaluation information that is used to determine whether to overwrite the firmware, and is written to a predetermined data area in the firmware storage area of the electronic device.

An electronic device according to another aspect of the invention has a firmware storage area where the firmware described above is written, and part of the firmware storage area is an evaluation area for determining whether to overwrite the firmware.

### EFFECT OF THE INVENTION

The invention can easily determine whether the firmware can be overwritten because it only needs to read the evaluation data to be written to a fixed address (evaluation area) in the firmware memory from the data for overwriting the firmware. Unlike simple version information, the information written to the evaluation area can be set to content enabling determining the compatibility of the firmware with the electronic device. Overwriting the current firmware with incompatible firmware can therefore be prohibited by referring to the evaluation data to be written to the evaluation area. Overwriting firmware with incompatible firmware can therefore be reliably prevented without unnecessarily restricting overwriting the firmware.

Other objects and attainments together with a fuller understanding of the invention will become apparent and appreciated by referring to the following description and claims taken in conjunction with the accompanying drawings.

### BRIEF DESCRIPTION OF THE DRAWINGS

FIG. 1 is a block diagram of a printer according to the invention.

FIG. 2 describes the configuration of a flash ROM device that stores firmware.

FIG. 3A shows an example of the evaluation information and evaluation area.

FIG. 3B shows another example of the evaluation information and evaluation area.

FIG. 4A is a flow chart of a process for writing firmware in a printer.

FIG. 4B is a flow chart of a process for writing firmware in a printer.

FIG. 4C is a flow chart of a process for writing firmware in a printer.

FIG. 4D is a flow chart of a process for writing firmware in a printer.

### DESCRIPTION OF EMBODIMENTS

Preferred embodiments of a printer with firmware and a method of writing firmware to a printer according to the present invention are described below with reference to the accompanying figures.

### Printer

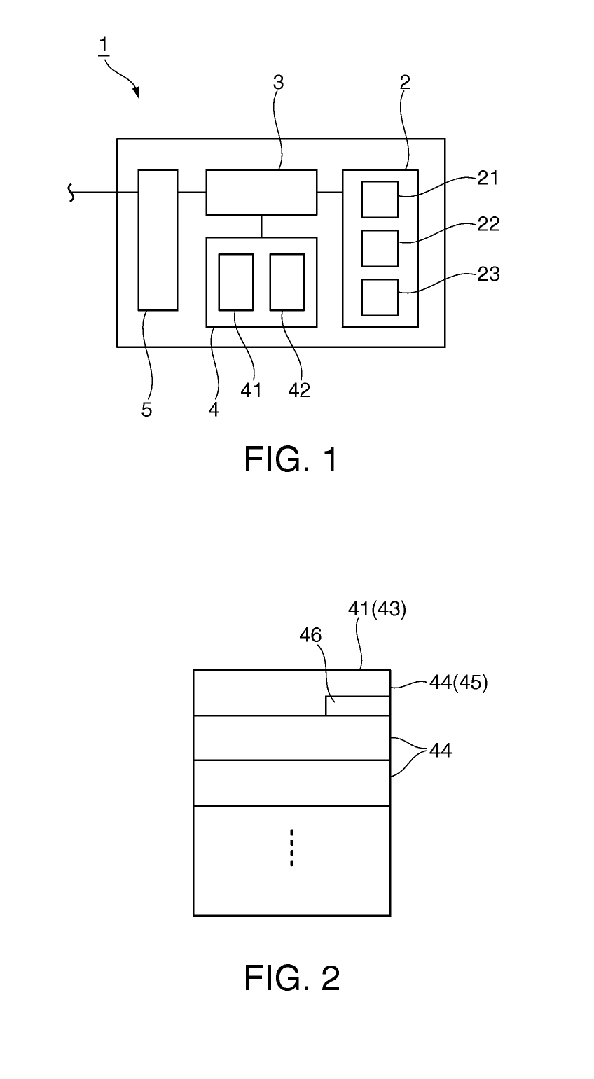

FIG. 1 is a block diagram of a printer according to the invention, and FIG. 2 describes the configuration of a flash ROM device that stores firmware.

As shown in FIG. 1, the printer 1 (electronic device) includes a print mechanism 2, control unit 3, storage unit 4, and communication unit 5. The print mechanism 2 is a configuration known from the literature, and in this embodiment includes a thermal head 21, platen roller 22, and motor 23 as a drive power source. The control unit 3 is a processor such as a CPU, and controls parts of the printer based on control commands and print data input from the communication unit 5, and programs and data read from the storage unit 4.

The storage unit 4 includes memory such as flash ROM 41 and RAM 42. As shown in FIG. 2, flash ROM 41 is used as firmware memory 43 for storing firmware. Alternatively, part of flash ROM 41 could be used as firmware memory 43, and the remaining memory used as storage for other data. Flash ROM 41 is divided into plural sectors 44, and data is written and erased by sector 44 unit (data unit). The first sector in the firmware memory 43 is a boot sector 45, and part of the boot sector 45 is an evaluation area 46 used to determine whether or not to permit overwriting the firmware.

### Firmware

The firmware according to this embodiment of the invention includes a main routine (the firmware) rendering the control functions for various parts of the printer 1, and a firmware writing routine (firmware writing program) controlling the firmware writing process. Both routines are written to a predetermined location and number of sectors 44 in the firmware memory 43. The firmware also includes evaluation information that is written to the evaluation area 46 in the boot sector 45. This evaluation information is data about the component parts that are controlled by the firmware, such as the specifications for the thermal head 21 and the motor 23. The same evaluation information is used for the configuration of parts compatible with being controlled by the firmware, and different evaluation information is set for configurations that are not compatible with the firmware.

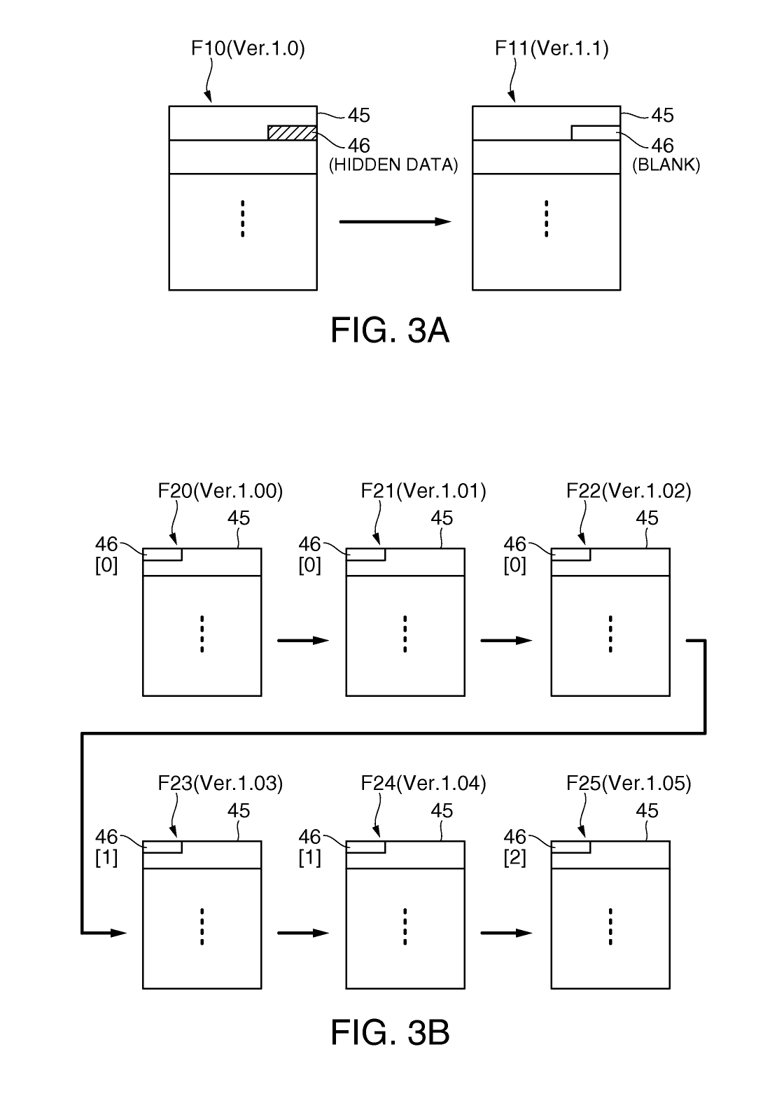

FIG. 3A and FIG. 3B describe examples of the evaluation information and evaluation area. The first example shown in FIG. 3A and the second example shown in FIG. 3B both show that different evaluation information is contained in the firmware before and after the firmware version is upgraded when parts that are incompatible with the initial control design are installed and the firmware is upgraded to accommodate the new parts.

Example 1 in FIG. 3A shows two (old and new) firmware versions for printers 1 of the same model. The old firmware F10 (version 1.0) is firmware compatible with a printer 1 having a thermal head 21 according to the original design specifications. The new firmware F11 (version 1.1) is firmware compatible with a printer 1 in which the thermal head 21 has been replaced with a new part that must be controlled in a different way than the original thermal head 21. The firmware F10 and F11 in this first example uses the data storage area at the end of the boot sector 45 in the firmware memory 43 as the evaluation area 46 to which the evaluation information is written. The evaluation information in the old firmware F10 is hidden data that is not used by the current (new) specifications of the printer 1. The new firmware F11 does not store data in the evaluation area 46, and the evaluation information is blank.

In the second example shown in FIG. 3B, upgraded versions of the firmware that change the control method to accommodate changes in the parts configuration, and upgraded versions of the firmware that are compatible with the same parts configuration but change other features, may be stored in the same model of printer 1. Six versions of firmware, version 1.00 to version 1.05, are shown in FIG. 3B. The firmware F20 to F25 in this second example uses the data storage area at the beginning (such as byte 1) of the boot sector 45 in the firmware memory 43 as the evaluation area 46 to which the evaluation information is written. The evaluation information in this second example describes a particular combination of thermal head 21 and motor 23. The evaluation information is set to 0 if both parts are the same as the original parts, 1 if only the thermal head 21 is changed, and 2 if both the thermal head 21 and motor 23 were replaced with new parts.

The three oldest versions of firmware F20 to F22 (versions 1.00 to 1.02) in this second example are compatible with a printer 1 in which the thermal head 21 and motor 23 are identical to the parts of the original design, and the evaluation information is set to 0.

The firmware is upgraded from firmware F22 to F23 (from version 1.02 to 1.03) when the original thermal head 21 is replaced with the new part, and the evaluation information is therefore also changed to 1 in firmware F23 (version 1.03). Like firmware F23 (version 1.03), firmware F24 (version 1.04) is compatible with configurations in which the thermal head 21 is a new part and the motor 23 is the original part, and the evaluation information therefore remains set to 1.

The firmware is upgraded from firmware F24 to F25 (from version 1.04 to 1.05) when the original motor 23 is replaced with the new part, and the evaluation information is therefore also changed to 2 in firmware F25 (version 1.05).

### Firmware Writing Method

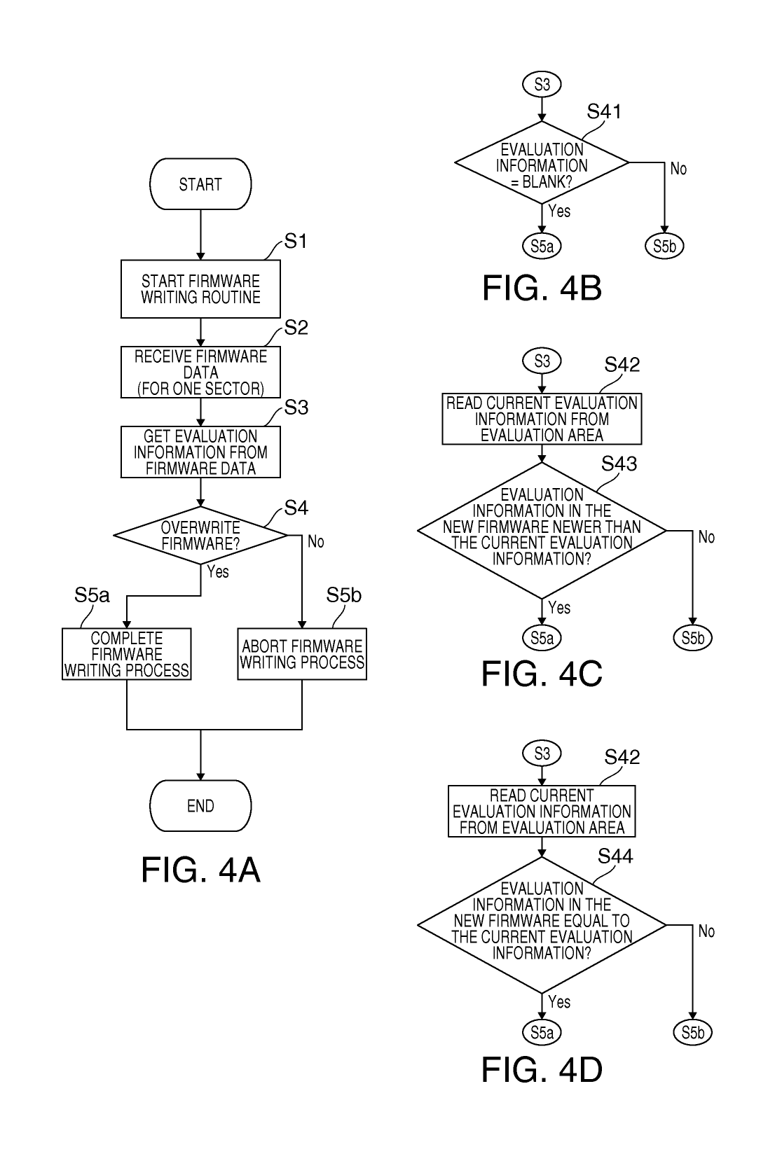

FIG. 4A to FIG. 4D are flow charts of the process for overwriting firmware in the printer 1, FIG. 4A showing the overall flow, and FIG. 4B to FIG. 4D showing subroutines for determining if overwriting the firmware is possible.

The control unit 3 of the printer 1 starts the firmware writing process when a control command to overwrite the firmware is received from a host device through the communication unit 5. In this process the control unit 3 first reads and writes the current firmware writing routine from firmware memory 43 to RAM 42 in step S1. The control unit 3 then runs the remainder of this process based on the firmware writing routine that is started in step S1. The control unit 3 then starts receiving the firmware data to be written from the host in step S2 (the first part of the first step in the accompanying claims). Because data is written by sector 44 in this embodiment, the data to be written to the first sector, sector 1, is received first and the received data is saved to RAM 42.

The evaluation information can also be acquired at this time because the evaluation area 46 is reserved in the first sector (boot sector 45). The control unit 3 then extracts the data to be written to the evaluation area 46, that is, the evaluation information contained in the new firmware (the evaluation data in the claims), from the received data to be written to the first sector (sector 1) in step S3 (the second part of the first step).

In step S4 (second step), the control unit 3 determines if the firmware can be overwritten based on the evaluation information extracted from the new firmware data. If overwriting is allowed (step S4 returns Yes), control goes to step S5a. The firmware writing process then ends in step S5a. More specifically, after the first sector is written using the data for one sector that has been completely received, the new firmware data is sequentially received in sector units, and the firmware is completely overwritten. If overwriting the firmware is not allowed (step S4 returns No), control goes to step S5b. A subroutine that aborts the firmware overwriting process is executed in step S5b.

The specific content of the evaluation process in step S4 differs according to the content of the evaluation information. FIG. 4B describes the process of determining if overwriting is allowed when the firmware is stored as shown in the first example in FIG. 3A. This routine executes only step S41 to determine if the evaluation information extracted from the new firmware data in step S3 is blank. If the data is blank (step S41 returns Yes), overwriting is allowed and control goes to step S5a. If the data is not blank (step S41 returns No), overwriting is not allowed and control goes to step S5b. This evaluation process only allows overwriting the current firmware with new firmware F11 in the first example shown in FIG. 3A, and does not allow overwriting the firmware to another version. This enables automatically detecting and preventing mistakenly rewriting the old firmware F10.

FIG. 4C describes the process of determining if overwriting is allowed when the firmware is stored as shown in the second example in FIG. 3B. In this process the control unit 3 first reads the data that is stored in the evaluation area 46 of the current firmware in step S42. In step S43, the control unit 3 then determines which is newer, the evaluation information in the current firmware (the information read from the evaluation area 46), or the evaluation information extracted in step S3 from the firmware data (overwrite data) to be written. Because the evaluation information with a value equal to the old evaluation information plus 1 is used as the new evaluation information, the newer evaluation information can be identified from the larger value.

If the evaluation information to be written is determined to be more recent than the current evaluation information (step S43 returns Yes), overwriting is allowed and control goes to step S5a. For example, if the evaluation information to be written is set to 1 and the value of the current evaluation information is 0 in the second example shown in FIG. 3B, overwriting is allowed.

However, if the evaluation information extracted from the overwrite data is determined to be older (step S43 returns No), overwriting is not allowed and control goes to step S5b. For example, if the evaluation information to be written is set to 1 and the value of the current evaluation information is 2 in the second example shown in FIG. 3B, overwriting is not allowed.

This evaluation process prohibits changing from firmware F23 (version 1.03) to an earlier version, and from firmware F25 (version 1.05) to an earlier version, in the second example, while allowing other changes. This enables preventing only overwriting the firmware to a version compatible with an older parts configuration while not prohibiting other upgrades. In addition, downgrades compatible with the same parts configuration, such as downgrading from firmware F24 (version 1.04) to firmware F23 (version 1.03) having the same evaluation information (1), can also be allowed.

FIG. 4D describes an evaluation process that is compatible with both the first and second example shown in FIG. 3A and FIG. 3B. As in the process shown in FIG. 4C, the control unit 3 first executes the same step S42 and retrieves the evaluation information in the current firmware. The control unit 3 then determines in step S44 if the evaluation information in the current firmware and the evaluation information extracted from the overwrite data (new firmware) are the same. If they are (step S44 returns Yes), overwriting is allowed and control goes to step S5a. If the values are not the same (step S44 returns No), overwriting is not allowed and control goes to step S5b. This evaluation process prohibits overwriting the firmware with firmware for a different parts configuration, and only allows overwriting the firmware with firmware compatible with the same parts configuration, in both the first and second examples shown in FIG. 3A and FIG. 3B.

### EFFECT OF THE INVENTION

As described above, evaluation information for determining whether or not to allow overwriting the firmware is stored in this embodiment at a fixed address in the firmware memory 43 of the printer 1, such as at the first address or the last address in the first sector. As a result, this information can be easily referenced when the firmware is overwritten, and whether or not to allow overwriting the firmware can be easily decided.

The evaluation information differs from simple version information, and is suitably set to content that enables determining the compatibility of the firmware with the electronic device. For example, by using information about the age or combination, for example, of parts, such as the thermal head 21 and motor 23, that are controlled by the firmware, the evaluation information can be set to enable determining the compatibility of the firmware with control of the actual parts when the parts may be changed or updated. This enables allowing overwriting the firmware with firmware that can correctly control the printer 1 while not allowing writing firmware that cannot correctly control the printer 1. Overwriting firmware with incompatible firmware can therefore be reliably prevented without restricting writing firmware that is compatible with the printer 1.

An evaluation area is reserved in the boot sector 45, which is the data writing unit to which data is written first to the firmware memory 43. Whether or not the firmware can be overwritten can therefore be determined as soon as the first sector of data is acquired after the overwriting process starts. Whether to allow overwriting can therefore be determined early in the firmware writing process, and the overwriting decision can be made in a short time. More particularly, whether to allow overwriting can decided at the earliest opportunity by providing the evaluation area 46 at the beginning of the boot sector 45.

### Other Embodiments

The foregoing embodiment applies the invention to a printer 1 and a method of overwriting firmware in a printer 1, but the invention can obviously be applied to other types of electronic devices that are controlled with firmware. Examples of such applications include devices that have a printer, scanners, fax machines, and projectors. In such applications the content of the evaluation information and the compatible parts configurations are obviously set appropriately to the particular device, and information about parts other than motors and heads can be used as the evaluation information.

The firmware described in the above embodiment can be run by a control unit that controls the electronic device. The firmware can also be provided stored on a suitable storage medium, including a hard disk drive, optical disc, magneto-optical disc, and flash memory.

The invention being thus described, it will be obvious that it may be varied in many ways. Such variations are not to be regarded as a departure from the spirit and scope of the invention, and all such modifications as would be obvious to one skilled in the art are intended to be included within the scope of the following claims.

What is claimed is:

1. A method of writing firmware in an electronic device, wherein:
part of the firmware storage area in the electronic device is reserved as an evaluation area for determining whether to allow overwriting the firmware; and
a control unit of the electronic device executes a first step of starting to acquire overwrite data for overwriting the firmware, and acquiring evaluation data for overwriting the evaluation area, based on input of a firmware overwrite command,
a second step of deciding whether to overwrite the firmware based on the content of the acquired evaluation data, and
completes overwriting the firmware when overwriting the firmware is allowed in the second step.

2. The method of writing firmware in an electronic device described in claim 1, wherein:
the electronic device has a plurality of parts that are controlled by the firmware; and
the evaluation area is a data area where information about at least one of the plural parts is written.

3. The method of writing firmware in an electronic device described in claim 1, wherein:
the control unit of the electronic device compares data read from the evaluation area with the evaluation data in the second step, and determines that overwriting is not allowed if the data differ.

4. The method of writing firmware in an electronic device described in claim 1, wherein:
the control unit of the electronic device determines whether the data read from the evaluation area or the evaluation data is newer in the second step, and allows overwriting only if the evaluation data is newer than the data read from the evaluation area.

5. The method of writing firmware in an electronic device described in claim 1, wherein:
the evaluation area is reserved in the unit data storage area where data is written first in the firmware storage area.

6. The method of writing firmware in an electronic device described in claim 1, wherein:
the electronic device is a printer or a device having a printer; and
the evaluation area is a data area where information about a thermal head or motor in the printer is written.

7. A storage medium storing firmware that can be run by a control unit of an electronic device, wherein:
the firmware includes a firmware writing program to execute the firmware writing method described in claim 1;
firmware to control the electronic device; and
evaluation information that is used to determine whether to overwrite the firmware, and is written to a predetermined data area in the firmware storage area of the electronic device.

8. An electronic device comprising:
a firmware storage area where the firmware, executing writing method described in claim 1, is written;
wherein part of the firmware storage area is an evaluation area for determining whether to overwrite the firmware.
